(19) United States
(12) Patent Application Publication
(10) Pub. No.: US 2015/0332318 A1
(43) Pub. Date: Nov. 19, 2015

(54) SYSTEM AND METHOD FOR OBTAINING A RELEASE AUTHORIZATION

(71) Applicant: CDK Global, Inc., Hoffman Estates, IL (US)

(72) Inventors: Sarah Gauss, Houston, TX (US); Andrew Largent, Seattle, WA (US); Lee Brunz, Seattle, WA (US)

(21) Appl. No.: 14/279,126

(22) Filed: May 15, 2014

(51) Int. Cl. G06Q 30/02

(52) U.S. Cl. CPC G06Q 30/0248; G06Q 50/01

(57) ABSTRACT

A computerized method, computing device, and storage medium obtaining a release authorization for social media content. The computerized method comprises selecting a promotional content on a social platform; capturing contact information of an individual associated with the promotional content; presenting a release form for authorizing the use of the promotional content to the individual associated with the promotional content; capturing authorization data associated with the release form; and storing the authorization data associated with the release form.

### BACKGROUND

1. Field of the Present Disclosure

The present application relates generally to systems and methods for obtaining a release authorization from an individual. More specifically, the present application relates to systems and methods for obtaining the authorization of a media release and the use of social media content of a third party.

2. Background Discussion

Social networking websites allow individuals to build relationships by having direct online interactions with each other. This particular form of communication has created a new type of online content generators, the user themselves. The contents generated by ordinary users of the Internet represent one of the fastest growing forms of content on the Internet. User Generated Content (UGC) may refer to any material created by non-media users or media professionals. For example, a UGC may include a comment or answer on Amazon.com, a video uploaded to YouTube.com, a tweet posted on Twitters.com, a story on Blog.com, or a student's profile on FaceBook.com.

Commercial companies also maintain online social channels with current or potential customers in addition to traditional ways of communicating with consumers. Networking means, including company's own website, social networking sites, and cell phone text messages, broadens the availability and accessibility of advertisement, recall, promotion, and warnings of products and services. Twitter, for example, allows individual followers of a company to “retweet” or “repost” comments, experiences, and ratings on products, promotional events, or even future product lines of the company. This kind of personal interactions between consumers and companies can generate a feeling of loyalty into followers and potential customers.

Presently, almost every company, agency, firms, political campaign, or social event has its own channel or means on social networking platforms to market their brands, product, candidate, and services. Very often, companies may want to use user-generated-contents on social networking platforms in a promotional event to advertise their services or products. To comply with the relevant copyright and privacy laws, an entity, who is planning an advertising campaign, is required to obtain authorization from relevant parties to use online contents created by them and to release their information such as photos or name to social media. But, current functions of a website or a social media platform do not provide such a feature to a promoting entity to obtain these consents from all relevant parties.

### SUMMARY OF THE INVENTION

According to an aspect, the present application is directed to a computerized method for obtaining a release authorization for social media content. The computerized method comprises selecting, by at least one computing device, a promotional content on a social platform; capturing, by the at least one computing device, contact information of an individual associated with the promotional content; presenting, by the at least one computing device, a release form for authorizing the use of the promotional content to the individual associated with the promotional content; capturing, by the at least one computing device, authorization data associated with the release form; and storing, by the at least one computing device, the authorization data associated with the release form.

According to an embodiment, the computerized method further comprises offering, by the at least one computing device, a reward to the individual associated with the promotional content for authorizing the use of the promotional content and/or offering, by the at least one computing device, a reward corresponding to a level of authorization to use the promotional content.

According to an embodiment, the reward includes a gift or coupon.

According to yet another embodiment, the computerized method further comprises publishing the promotional content according to the level of the authorized use.

According to yet another embodiment, the authorization data includes a signature of the individual associated with the promotional content and/or a unique identifier of the release form and/or a device identification of the device used by the individual to authorize the use of the promotional content and/or the individual's fingerprints or retinal scan.

According to yet another embodiment, the device used by the individual to authorize the use of the promotional content includes a mobile phone or a tablet.

According to yet another embodiment, the computerized method further comprises providing a copy of the authorized release form to the individual associated with the promotional content.

According to yet another embodiment, the copy is provided via email or instant message.

According to another aspect, the present application is directed to a computing device comprising a processor configured to implement the computerized method of obtaining the release authorization from social media content.

According to another aspect, the present application is direct to a computing device for creating social media content comprising a processor configured to implement the following steps: identifying social media content; obtain authorization to modifying the identified content to create new content therefrom; and publishing the modified content.

According to an embodiment, the authorization relates to a plurality of levels of privacy.

According to another aspect, the present application is directed to a storage medium storing an executable program that, when executed, instructs a processor to execute the above described computerized method of obtaining the release authorization from social media content.

### BRIEF DESCRIPTION OF DRAWINGS

To the accomplishment of the foregoing and related ends, certain illustrative embodiments of the invention are described herein in connection with the following description and the annexed drawings. These embodiments are indicative, however, of but a few of the various ways in which the principles of the invention may be employed and the present application is intended to include all such aspects and their equivalents. Other advantages, embodiments and novel features of the invention may become apparent from the following description of the present invention when considered in conjunction with the drawings. The following description, given by way of example, but not intended to limit the present invention solely to the specific embodiments described, may best be understood in conjunction with the accompanying drawings, in which:

FIG. 1 illustrates an embodiment of a system 100 for obtaining release authorizations from a content creator.

FIG. 2 illustrates an embodiment of an electronic device 200 capable of being used with the social media management system.

FIG. 3a illustrates a social media publishing method 300 according to an embodiment of the present application.

FIG. 3b illustrates a method 310 for obtaining the release authorization of a third-party according to an embodiment of the present application.

FIG. 4 illustrates a screen shot 400 for obtaining the release authorization of a third party according to an embodiment of the present application.

### DETAILED DESCRIPTION

Those of ordinary skill in the art will realize that the description of the present invention is illustrative only and not in any way limiting. Other embodiments will readily suggest themselves to such skilled persons, having the benefit of this disclosure. Reference will be made in detail to specific implementations of the present invention as illustrated in the accompanying drawings.

Further, certain figures in this specification are flow charts illustrating methods and systems. It will be understood that each block of these flow charts, and combinations of blocks in these flow charts, must be implemented by computer program instructions. These computer program instructions may be loaded onto a computer or other programmable apparatus to produce a machine, such that the instructions which execute on the computer or other programmable apparatus create structures for implementing the functions specified in the flow chart block or blocks. These computer program instructions may also be stored in a computer-readable memory or a storage medium that can direct a computer or other programmable apparatus to function in a particular manner, such that the instructions stored in the computer-readable memory or storage medium produce an article of manufacture including instruction structures which implement the function specified in the flow chart block or blocks. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flow chart block or blocks.

Accordingly, blocks of the flow charts support combinations of structures for performing the specified functions and combinations of steps for performing the specified functions. It will also be understood that each block of the flow charts, and combinations of blocks in the flow charts, can be implemented by special purpose hardware-based computer systems which perform the specified functions or steps, or combinations of special purpose hardware and computer instructions.

For example, any number of computer programming languages, such as C, C++, C#(CSharp), Perl, Ada, Ruby, Python, Pascal, SmallTalk, FORTRAN, assembly language, and the like, may be used to implement aspects of the present application. Further, various programming approaches such as procedural, object-oriented or artificial intelligence techniques may be employed, depending on the requirements of each particular implementation. Compiler programs and/or virtual machine programs executed by computer systems generally translate higher level programming languages to generate sets of machine instructions that may be executed by one or more processors to perform a programmed function or set of functions.

The term “machine-readable medium” or “storage medium” can be understood to include any structure that participates in providing data which may be read by an element of a computer system. Such a medium may take many forms, including but not limited to, non-volatile media, volatile media, and transmission media. Non-volatile media include, for example, optical or magnetic disks and other persistent memory. Volatile media include dynamic random access memory (DRAM) and/or static random access memory (SRAM). Transmission media include cables, wires, and fibers, including the wires that comprise a system bus coupled to processor. Common forms of machine-readable media include, for example, a floppy disk, a flexible disk, a hard disk, a magnetic tape, a compact flash card, a smart media cart, a SMS card, any other magnetic medium, a CD-ROM, a DVD, or any other optical medium.

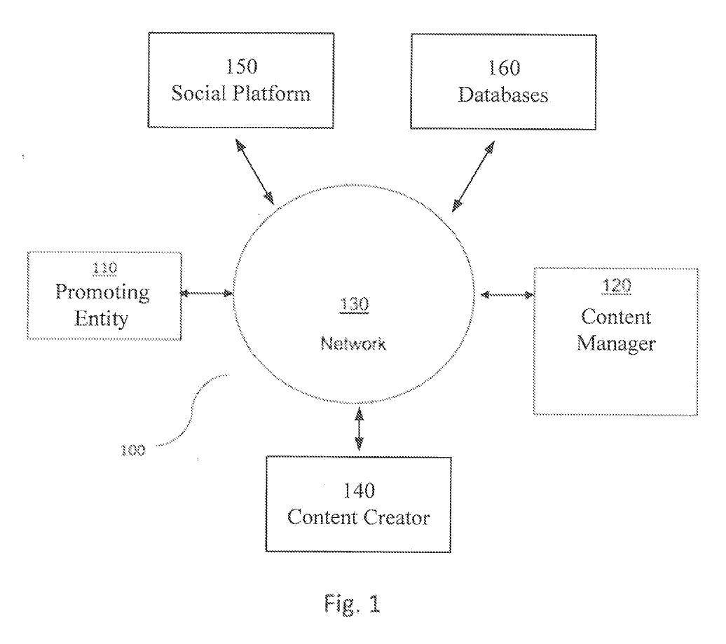

FIG. 1 illustrates a system 100 for managing a promotional event and obtaining release authorizations of relevant parties according to an embodiment of the present application. As illustrated, the system 100 includes terminals of promoting entities 110, terminals of a content manager 120, networks 130, a third party's terminals 140, social platforms 150, and databases 160. The exemplary simplified number of terminals illustrated in FIG. 1 can be modified as appropriate in a particular implementation. In practice, there may be additional terminals 110, terminals 120, networks 130, terminals 140, social platforms 150, and databases 160.

The terminal 110 may be any device used by an employee or a representative of a promoting entity to access the network 130. The terminal 110 may be a computer, laptop, tablet, phone, mobile phone, or any other electronic devices that is capable of retrieving information via the network 130 and presenting retrieved information to a user. The employee or representative uses the terminal 110 to collect contents for a promotional event and create promotional materials or publications for the promotional event. According to an embodiment, the employee or representative accesses the social platforms 150 to search and discover desirable social media contents published by ordinary users of the social platforms. The social media contents may include images, videos, audios, blogs, comments, ratings, discussions, and/or experiences associated with a service, a product, a sales or promotional event, or a company.

According to an embodiment, the promoting entity may include any type of business entities from for-profit organizations to non-profit organizations. The promoting entity may be the organizations themselves or may be a public relation agency or advertising agency who manages promotions on behalf of another organization. According to an embodiment, the entity also includes a government agency. The areas of business includes sports, automobile, antique, art, machine, consumer goods, bonds and/or securities.

According to an embodiment, the system 100 provides functions to the promoting entity and their employees to create a promotional event by using social media contents, to make promotions among a local customer base, and to reply to trends of reviews and comments on a social network. The system 100 also provides a function to the promoting entity to obtain release authorizations of relevant parties or individuals who have legal rights on those social media contents that may be used in a promotional event. The release authorization may also include authorizations for using the relevant party's information in a social media release. The relevant parties or individuals may include the content creator who creates the content and those individuals or parties who are part of the content. The relevant parties may also include whoever publishes the social media content or whoever manages the social media contents, such as the company that operates the social media platforms.

A promotional event may include any activity, effort, publication, incentives, discounts, advertisement, or any material that aims to raise customer awareness of a product or brand, generate sales, and/or create brand loyalty. According to an embodiment, a promotion event includes a social media post or a promotional publication to be published on a social platform in order to raise customer awareness of a product or brand, generate sales, and create brand loyalty. The social medial post or promotional publication may include an icon, text messages, a link, an image, audios, and/or videos.

By an implementation of the present application, a car dealership may use the system 100 for a promotion. After a customer completes a transaction with a dealer, such as buying a car, a dealer may be able to use the experience of the customer to create a promotional event. For example, the customer may accept an interview with the dealer's representative and talk about his or her experiences during the transaction. The customer may also post his or her story, image, or video on a social platform by himself or herself. The dealer may desire to use any of these materials to create a promotional event, such as a social media post, to raise the reputation and/or brand loyalty and/or increase sales. Before the publication of the promotional event, the dealer uses the system 100 to obtain the consent of the customer to allow the dealer to use contents created by the customer and/or the customer's personal information such as name of the customer and transaction information. After the customer authorizes the release, the dealer may use the system 100 to provide a copy of the consent to the customer.

According to an embodiment, the third party's terminal 140 is used by a user to connect with the network 130 and the social platform 150. The user may not only enjoy reading communications from his or her peers, but also generate and publish contents on the network 130 and the social platform 150. The generated contents include comments, ratings, images, audios, videos, articles, and any other similar forms of expressions that are made available on a website or a social platform 150. Although the contents are published on the network 130, the contents are not free for anyone to use, especially to use in a commercial context. The user, who creates the contents, is likely to be required to accept an agreement with the operator of a publication website that is selected by the user to publish his or her created contents. The agreement typically authorizes the publication website to use the user created content without additional release authorizations from the user. But, anyone else, such as a promoting entity, may still be required to secure a release authorization of the user if the user created content and/or personal information of the user may be used in a promotional event.

The terminal of the content manager 120 may be used for creating, reviewing, editing, and publishing a promotional event. The terminal 120 is be used to obtain consent from content creators. According to an embodiment, some or all of the terminal 110, the terminal 140, and/or the content manager terminal 120 may be combined or may be represented by one terminal without affecting the functions thereof.

According to an embodiment, the system 100 provides a browser based interface to a user. The user may use an electronic device, such as a server, a computer, a mobile phone, a tablet, a laptop, or a TV, to connect to the network. The system 100 may allow a user to install dedicated software on an electronic device and execute the software to make connections to the terminal 120 and input data. According to an embodiment, the terminal 120 may be associated with any of the terminals as shown in FIG. 1 through any suitable tangible computer-readable media or data storage device (such as a disk drive, CD-ROM, DVD, or the like).

Network 130 may include one or more networks of any type, including a Public Land Mobile Network (PLMN), a telephone network (e.g., a Public Switched Telephone Network (PSTN) and/or a wireless network), a local part network (LAN), a metropolitan part network (MAN), a wide part network (WAN), an Internet Protocol Multimedia Subsystem (IMS) network, a private network, the Internet, an intranet, and/or another type of suitable network, depending on the requirements of each particular implementation.

The social platform includes social media or social network websites, such as FaceBook, Google+, MySpace, and FourSquare. Social platforms also include information networks or social information networks such as Twitter, YouTube, Flickr, and Digg. Social platforms also include those websites who have network functions, such as blogs, bulletin board, comment board, discussion page, or advice page that facilitate to a greater extent participatory information sharing, interoperability, user-centered design, and collaboration than Web 1.0 websites. The social platform 150 may represent many terminals operated by a same party and allow input from many countries in many languages.

The databases 160 may be a centralized server, several connected and distributed servers, or a cloud based storage system. The database 160 stores business information of a promoting entity, which includes promotional events, customer information, employee information, and etc.

The database 160 also stores the consent of a third party that authorizes the promoting entity to use the third party created information and contents in a promotional event.

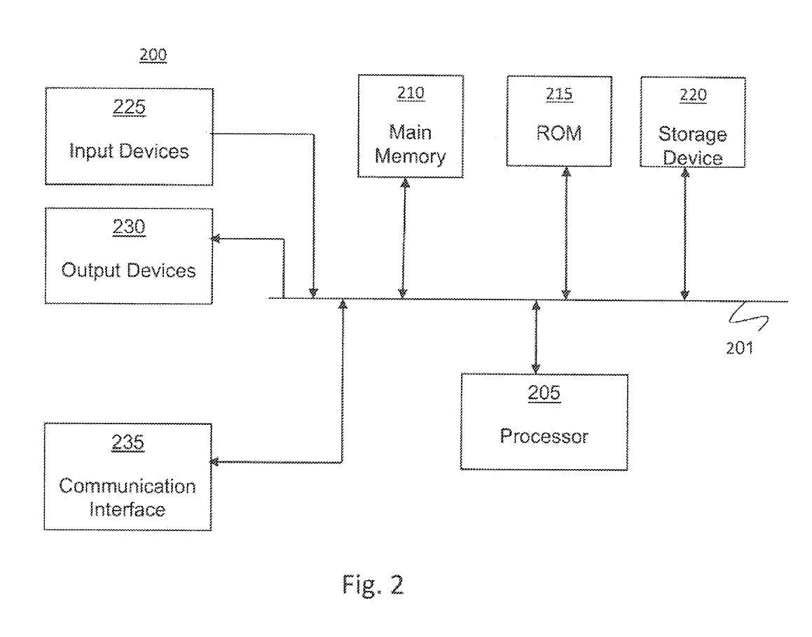

FIG. 2 is an exemplary diagram of an electronic device 200 that may be used to implement aspects of certain embodiments of the present application, such as aspects of the terminals 110, terminals 120, networks 130, terminals 140, social platform 150, and databases 160. The following examples illustrate a few implementations of the electronic device, including any desktop computer, any laptop, any server, any tablet such as iPad, any mobile phone such as iPhone, any computer device designed for a general or particular application such as Netbook, and similar devices.

The electronic device 200 may include a bus 201, one or more processors 205, a main memory 210, a read-only memory (ROM) 215, a storage device 220, one or more input devices 225, one or more output devices 230, and a communication interface 235. Bus 201 may include one or more conductors that permit communication among the components of the electronic device 200.

Processor 205 may include any type of conventional processor, microprocessor, or processing logic that interprets and executes instructions. Moreover, processor 205 may include processors with multiple cores. Also, processor 205 may be multiple processors. Main memory 210 may include a random-access memory (RAM) or another type of dynamic storage device that stores information and instructions for execution by processor 205. ROM 215 may include a conventional ROM device or another type of static storage device that stores static information and instructions for use by processor 205. Storage device 220 may include a magnetic and/or optical recording medium and its corresponding drive.

Input device(s) 225 may include one or more conventional mechanisms that permit a user to input information to the electronic device 200, such as a keyboard, a mouse, a pen, a stylus, handwriting recognition, touch screen display, voice recognition, biometric mechanisms, and the like. Output device(s) 230 may include one or more conventional mechanisms that output information to the user, including a display, a projector, an A/V receiver, a printer, a speaker, and the like. Communication interface 235 may include any transceiver-like mechanism that enables the electronic device 200 to communicate with other devices and/or systems. For example, communication interface 235 may include mechanisms for communicating with another device or system via a network, such as network 130 as shown in FIG. 1.

As will be described in detail below, electronic device 200 may perform operations based on software instructions that may be read into memory 210 from another computer-readable medium, such as data storage device 220, or from another device via communication interface 235. The software instructions contained in memory 210 cause processor 205 to perform processes that will be described later. Alternatively, hardwired circuitry may be used in place of or in combination with software instructions to implement processes consistent with the present application. Thus, various implementations are not limited to any specific combination of hardware circuitry and software.

A web browser comprising a web browser user interface may be used to display information (such as textual and graphical information) on the electronic device 200. The web browser may comprise any type of visual display capable of displaying information received via the network 130 shown in FIG. 1, such as Microsoft's Internet Explorer browser, Mozilla's Firefox browser, Apple's Safari browser, Google's Chrome browser or any other commercially available or customized browsing or other application software capable of communicating with network 130. The electronic device 200 may also include a browser assistant. The browser assistant may include a plug-in, an applet, a dynamic link library (DLL), or a similar executable object or process. Further, the browser assistant may be a toolbar, software button, or menu that provides an extension to the web browser. Alternatively, the browser assistant may be a part of the web browser, in which case the browser would implement the functionality of the browser assistant.

The browser and/or the browser assistant may act as an intermediary between the user and the electronic device 200 and/or the network 130. For example, source data or other information received from devices connected to the network 130 may be output via the browser. Also, both the browser and the browser assistant are capable of performing operations on the received source information prior to outputting the source information. Further, the browser and/or the browser assistant may receive user input and transmit the inputted data to devices connected to network 130.

Similarly, certain embodiments of the present application described herein are discussed in the context of the global data communication network commonly referred to as the Internet. Those skilled in the art will realize that embodiments of the present application may use any other suitable data communication network, including without limitation direct point-to-point data communication systems, dial-up networks, personal or corporate Intranets, proprietary networks, Cloud network, or combinations of any of these with or without connections to the Internet.

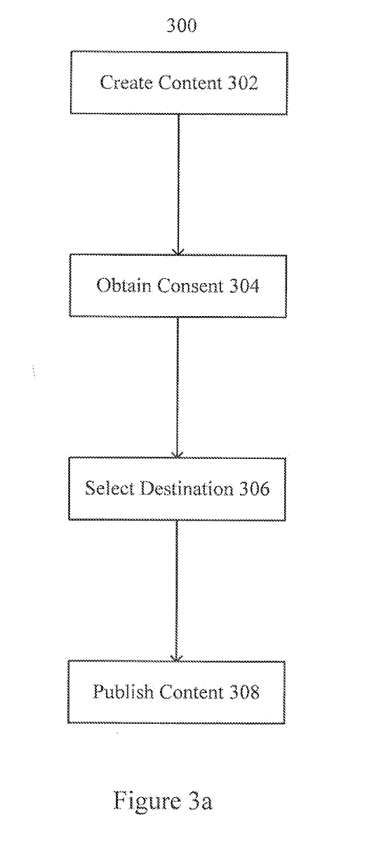

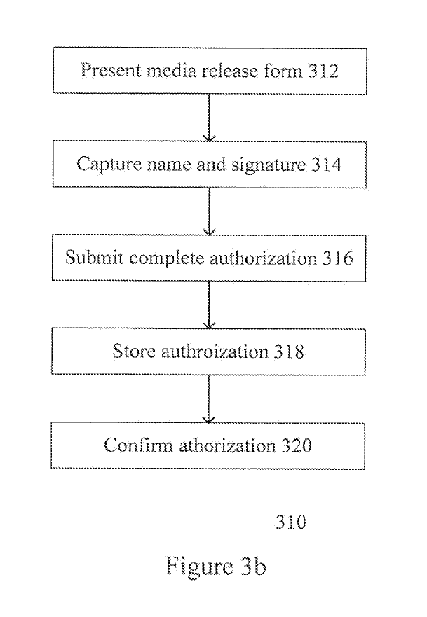

FIG. 3a illustrates an overview of a method 300 for managing a promotional event according to an embodiment of the present application. The method 300 includes a step 302 for creating a promotional publication, such as a social media post on a social platform, a step 304 for obtaining the release authorization from relevant parties or individuals, a step 306 for selecting websites to publish the created publication, and a step 308 for publishing the promotional publication.

In step 302, the promoting entity creates a promotional publication, such as an article, a video, or a social medial post. According to an embodiment, the promotional publication uses information of a real customer such as name, picture, address, video, testimony, or interview as part of the promotional publication. According to an embodiment, the information of a real customer may be uploaded by the customer to a device of the promoting entity. The information of a real customer may include an image of the customer showing satisfaction with the transaction. According to an embodiment, the information of a real customer may be captured from a social media post published on a social networking website by the same customer. For example, if the customer publishes his or her car buying experience with a dealer on FaceBook, the dealer may be able to discover the post and may capture images or comments in that post to create a promotional publication.

In step 304, the promoting entity obtains consents from relevant parties or individuals. For example, a third party who is included in a promotional publication or a third party who publishes a social content usable in a promotional publication are contacted to obtain a release authorization. The promotional publication may include contents produced by plural parties, respectively. For example, the publication may include testimonies or interviews of multiple customers. After the promoting entity discovers a content that may be used in the publication, the promoting entity captures the contact information of relevant parties such as an account name on a social platform, address, and email. The promoting entity uses the system 100 to generate a release authorization form for the relevant parties, assign a unique form identifier to the consent form, and provide the consent form electronically to the relevant parties.

According to an embodiment, the unique form identifier is formed by a plurality of numerical values representing the total number of generated forms till that time. According to another embodiment, the unique form identifier is formed by a predetermined length of randomly generated symbols. According to other embodiments, the unique form identifier may include information on promotional event and date and time when the form is created. According to another embodiment, the unique form identifier may represent a hash value of the release form.

The step 304 allows a party to manifest his or her consent to the release authorization in many forms. For example, a relevant party may provide a personal signature or use an electronic signature. The relevant party may express his or her consent by simply submitting the release form to the promoting entity. The step 304 further captures the authorization data and stores the authorization data in the database 160. According to an embodiment, the authorization data and the release form are encrypted before they are stored in the database 160. According to another embodiment, any personal information such as name, address, signature, account name, and phone number are encrypted before they are stored. In step 304, the content creator is further provided a copy of the signed authorization form to the relevant party either by mail or by an electronic method such as by email, fax, and instant message.

In step 306, social platforms are selected to publish the promotional event. Social platforms are selected based on a plurality of criteria, including whether the promoting entity has an account or not, how many social connections the entity has on a social networking website, what is the subject of a specific social connection group, and/or what the geographical distributions of connections among local and national regions are. One or more social networks may be selected for publication. The step 306 allows the promoting entity to publish a promotional event on plural social networks simultaneously, such as by using “one click” function to publish a promotional event in multiple social networks. The step 304 also allows the promoting entity to schedule the publication of a promotional event or plural promotional events.

FIG. 3b illustrates a method 310 for obtaining the release authorization of relevant parties. In step 312, a release form is presented to the relevant parties or individuals associated with contents to be used in a promotional publication. According to one embodiment, the contents are discovered on a social networking website. These contents may include an article published on a website, a comment in an online forum, a rating to a product, a mood expression on a social medial website, an image shared among an online group, and a video uploaded to a website. In step 312, the content may be discovered through a search by using the name or other identification information of a service or product related to the promoting entity. Once the content is discovered, the contact information of the party who creates and/or publishes the content is captured. In step 312, a release form is created and is provided to the relevant party either by a conventional method, such as by mail or by a personal delivery, or by an electronic method, such as by email or by fax. In step 312, the electronic method is preferably used.

According to an embodiment, incentives may be offered to relevant parties together with the release form. The incentives may include cash reward, product reward, service reward, coupons, discounts, promotions, recognitions, and etc. According to an embodiment, the release form includes various levels of release authorization. A relevant party may authorize the use or his or her information with magazine advertisement, TV advertisement, email campaign, individual website advertisement, social media publication, and etc. The level of the release authorization may also be related to privacy. The incentive enjoyed by relevant parties may be offered according to the level or scope of the authorization by those relevant parties. For example, if a party provides unconditioned authorization, that party may enjoy all available incentives associated with a promotional event. If a party authorizes the use of his or her content only to online publications, that party's incentive may be reduced to a predetermined level.

In another embodiment, the content to be used in the promotional publication is captured in person. For example, an interview is conducted between the promoting entity and the third party. Before or after the interview, the third party is provided with a release form either by the conventional method or by the electronic method.

In step 314, the third party or the content creator provides his or her authorization on the release form. The authorization may be manifested by his or her signature on a predetermined part of the form. The authorization may be manifested by his or her acceptance of an offer provided by the promoting entity. The authorization may also be manifested by his or her submission of the release form to the promoting entity.

Upon a detection of the authorization, the step 314 captures authorization data associated with the release form. The authorization data includes the signature of the third party, the name of the third party, contact information of the third party, the date and time when the release form is authorized, the device information used for authorizing the release form, the geolocation (such as the GPS data) when the form is authorized, the description of the content to be used, and the terms of the release form. According to an embodiment, the step 314 captures a screen shot of the signature portion as the authorization data.

In step 316, the authorized release form is submitted to the promoting entity. In step 318, the method 310 assigns a unique identifier to the release form and stores the identifier, the release form, and the authorization data in the database 160. The method 310 also associates the release form with the identification information of the promotional publication and the service or product to be promoted. In step 320, a copy of the authorized release form is provided to the third party by either the conventional method or by the electronic method.

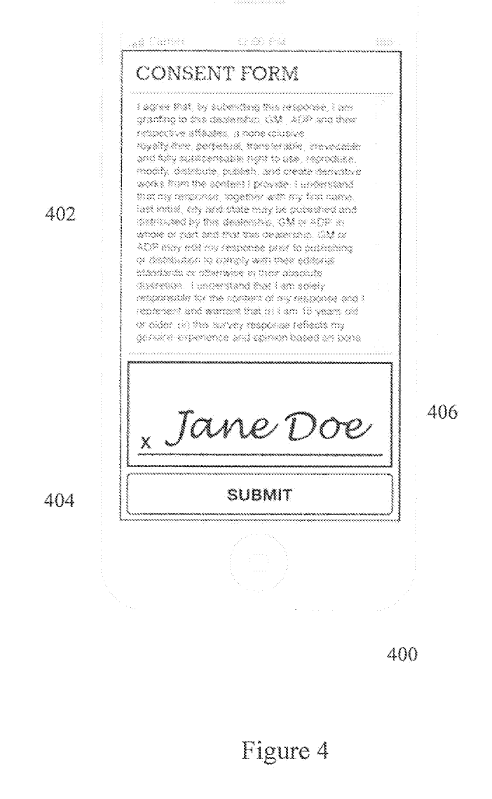

FIG. 4 illustrates a screen shot 400 for obtaining consent regarding the use of the social media content from a third-party. The computing device displays the terms of the consent form 402 to the third-party. The terms of the consent form 402 may indicate, among things, that the promoting entity is authorized to use the third-party's name and content in a promotional publication and the level of the authorization, to modify the content, to publish the content, to combine the content with other contents, and etc. According to an embodiment, the release form categorizes the level of authorization into a few categories, such as TV, paper publication, online publication, email, and social media, so that a party can select one or more categories. The consent form 402 may also include descriptions of the content that is created by the third party and that is to be used in the promotional publication. If this is acceptable, the third-party may sign his name on the signature line 406. The third-party may use his or her personal signature on the line 406 or may use an electronic signature on the line 406. The user is provided with a function 404 that submits the consent form electronically to the promoting entity, which may proceed to capture content, such as images, videos, or texts published by the thirty party on a social platform. Upon submission, the method 310 may captures date and time of the submission, identification information of the device used by the third-party, a screen shot of the form, a screen shot of the signature line, the electronic data of the release authorization form. The release authorization form is assigned a unique identifier and stored in the database together with the captured data.

According to an embodiment, the device as shown in FIG. 4 represents a mobile computing device such as a mobile phone. The identification of the mobile computing device, such as a phone number and a card number of a phone, may be obtained and included in the authorization data. According to another embodiment, the individual's biometrics may also be captured as the authorization data. For example, the individual's fingerprints or retinal scan may be obtained via the device as shown in FIG. 4 as part of the authorization data.

The system and method as set forth in the present application provides the abilities to present and capture a content release authorization during the content creation workflow from a mobile or desktop device. The system and method are capable of capturing and storing authorization prior to the publication of a promotional material. Thus, the system and method of the present application aid businesses with creating promotional content for commercial use. It is preferable to obtain consent to the taking, recording, use and publication of person's photograph and/or audiovisual recordings and images by a business in any of its written, electronic and audiovisual materials and publications, including, but not limited to social media sites, websites, digital advertisements, magazines and other printed materials, advertisements, brochures and videos.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

What is claimed is:

1. A computerized method for obtaining a release authorization for social media content, comprising:
selecting, by at least one computing device, a promotional content on a social platform;
capturing, by the at least one computing device, contact information of an individual associated with the promotional content;
presenting, by the at least one computing device, a release form for authorizing the use of the promotional content to the individual associated with the promotional content;
capturing, by the at least one computing device, authorization data associated with the release form; and
storing, by the at least one computing device, the authorization data associated with the release form.

2. The computerized method of claim 1, further comprising:
offering, by the at least one computing device, a reward to the individual associated with the promotional content for authorizing the use of the promotional content;

3. The computerized method of claim 2, further comprising:
offering, by the at least one computing device, a reward related to a level of authorization to use the promotional content.

4. The computerized method of claim 3, wherein the reward includes a coupon or gift.

5. The computerized method of claim 3, further comprising:
publishing the promotional content according to the level of the authorized use.

6. The computerized method of claim 2, wherein the authorization data includes a signature of the individual associated with the promotional content.

7. The computerized method of claim 6, wherein the authorization data includes a unique identifier of the release form.

8. The computerized method of claim 6, wherein the authorization data includes the individual's fingerprints or retinal scan.

9. The computerized method of claim 7, wherein the authorization data includes a device identification of the device used by the individual to authorize the use of the promotional content.

10. The computerized method of claim 9, wherein the device used by the individual to authorize the use of the promotional content includes a mobile phone or a tablet.

11. The computerized method of claim 2, further comprising:
providing a copy of the authorized release form to the individual associated with the promotional content.

12. The computerized device of claim 11, wherein the copy of the authorized release form is provided to the individual by email or instant message.

13. A computing device for obtaining a release authorization for social media content, comprising a processor configured to implement the following steps:
selecting a promotional content on a social platform;
capturing contact information of an individual associated with the promotional content; presenting a release form for authorizing the use of the promotional content to the individual associated with the promotional content;
capturing authorization data associated with the release form; and
storing the authorization data associated with the release form.

14. The computing device of claim 13 further configured to implement:
offering a reward to the individual associated with the promotional content for authorizing the use of the promotional content;

15. The computing device of claim 14 further configured to implement:
offering a reward related to a level of authorization to use the promotional content.

16. The computing device of claim 15, wherein the reward includes a coupon or gift.

17. The computing device of claim 15 further configured to implement:
publishing the promotional content according to the level of the authorized use.

18. The computing device of claim 14, wherein the authorization data includes a signature of the individual associated with the promotional content.

19. The computing device of claim 18, wherein the authorization data includes a unique identifier of the release form.

20. The computing device of claim 18, wherein the authorization data includes the individual's fingerprints or retinal scan.

21. The computing device of claim 19, wherein the authorization data includes a device identification of the device used by the individual to authorize the use of the promotional content.

22. The computing device of claim 21, wherein the device used by the individual to authorize the use of the promotional content includes a mobile phone or a tablet.

23. The computing device of claim 14 further configured to implement:
providing a copy of the authorized release form to the individual associated with the promotional content.

24. The computing device of claim 23, wherein the copy of the authorized release form is provided to the individual by email or instant message

25. A storage medium storing an executable program that, when executed, instructs a processor to execute a computerized method for obtaining a release authorization for social media content, the computerized method comprising:
selecting a promotional content on a social platform;
capturing contact information of an individual associated with the promotional content; presenting a release form for authorizing the use of the promotional content to the individual associated with the promotional content;
capturing authorization data associated with the release form; and
storing the authorization data associated with the release form.

26. The storage medium of claim 25, wherein the computerized method further comprises:
offering a reward to the individual associated with the promotional content for authorizing the use of the promotional content;

27. The storage medium of claim 26, wherein the computerized method further comprises:
offering a reward corresponding to a level of authorization to use the promotional content.

28. The storage medium of claim 27, wherein the computerized method further comprises:
publishing the promotional content according to the level of the authorized use.

29. The storage medium of claim 26, wherein the authorization data includes a signature of the individual associated with the promotional content.

30. The storage medium of claim 29, wherein the authorization data includes a unique identifier of the release form.

31. The storage medium of claim 30, wherein the authorization data includes a device identification of the device used by the individual to authorize the use of the promotional content.

32. The storage medium of claim 31, wherein the device used by the individual to authorize the use of the promotional content includes a mobile phone or a tablet.

33. The storage medium of claim 26, wherein the computerized method further comprises:
providing a copy of the authorized release form to the individual associated with the promotional content.

34. A computing device for creating social media content comprising a processor configured to implement the following steps:
identifying social media content;
obtain authorization to modifying the identified content to create a new content; and publishing the modified content.

35. The computing device of claim 34, wherein the authorization relates to a plurality of levels of privacy.
